(19) United States
(12) Patent Application Publication
(10) Pub. No.: US 2018/0080623 A1
(43) Pub. Date: Mar. 22, 2018

(54) Light Bulb Reflector

(71) Applicant: Maile Ledford Jones, Arvada, CO (US)

(72) Inventor: Maile Ledford Jones, Arvada, CO (US)

(21) Appl. No.: 14/869,557

(22) Filed: Sep. 29, 2015

(51) Int. Cl. F21V 7/04; F21V 7/22; F21V 21/088

(52) U.S. Cl. CPC F21V 7/04; F21S 8/04; F21V 21/088; F21V 7/22

(57) ABSTRACT

Technical field: lighting. This object is an accessory. It is a reflector that can be installed into an existing luminaire assembly, typically ceiling lights. This product creates more light. It is designed to sit above the light bulb. It is a reflector, is held up with a metal support that attaches to a light socket. The claim: An accessory reflector designed to sit on the side of a light bulb (bulb series A, B, C, G, P, RP) in a luminaire assembly, sized accordingly to bulb series and bulb shapes; containing any percentage of reflecting ability, comprised of any composition of materials that are ideal and suitable; The reflector piece having a fastening mechanism that fastens to a light socket, or having the ability to be attached to the light fixture in the most feasible manner.

### BACKGROUND OF THE INVENTION

This product was designed in pursuit to increase the amount of light that is emitted from a cfl or led light bulb through the use of reflection. The goal is to be able to eliminate the need for high watt bulbs. This product creates more light in ceiling luminaire assemblies without additional electricity, and reduces the need for high watt bulbs.

### BRIEF SUMMARY OF INVENTION

When this reflector is used in a lamp unit, additional light is created, which reduces the need for high watt bulbs. The effect of the use of this reflector in a lamp is an increase in total light.

### REFERENCE

a—Mirror
b—Steel

### DESCRIPTION OF VIEWS IN DRAWINGS

FIG. 1) This is a view from the top. This is the front of the mirror (a) end the fastening steel (b) piece almost a complete circle which is designed to fit around a light socket typically in a ceiling light luminaire assembly.

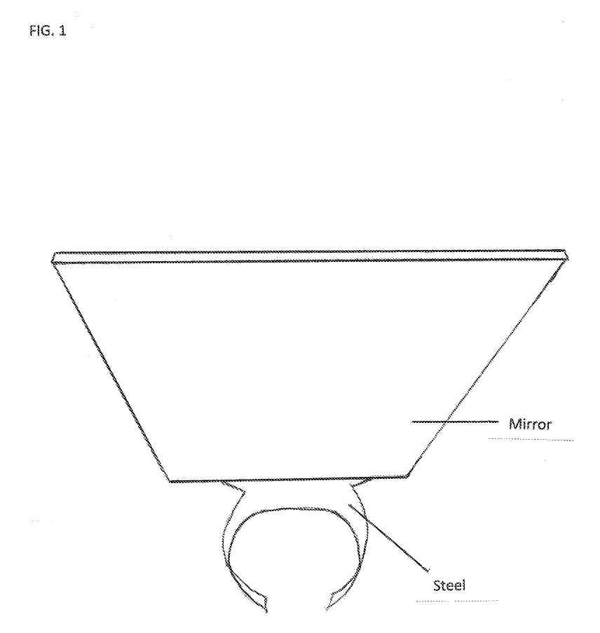

FIG. 2) This is a view from the side. This is the front of the mirror (a) and the fastening steel (b) piece which will typically line up with a light bulb's lower section and fasten around a light socket typically in a ceiling light luminaire assembly.

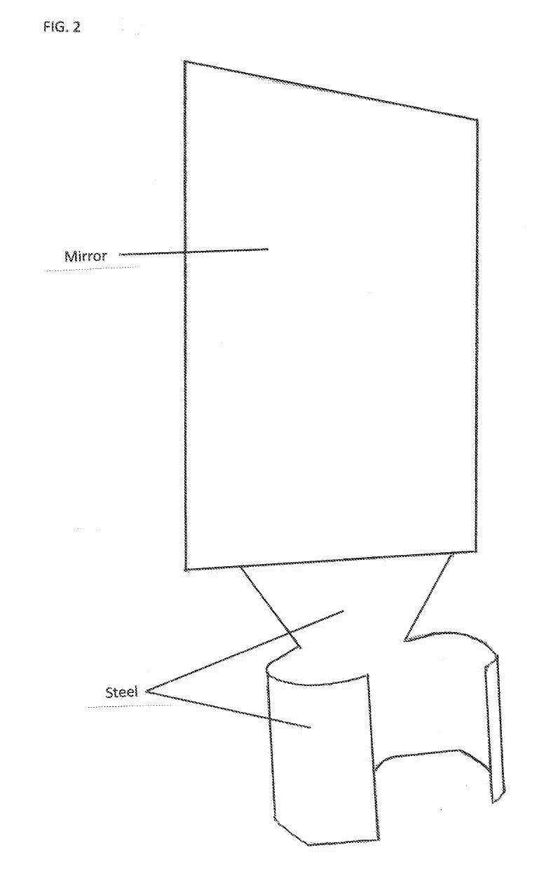

FIG. 3) This is a view from the back. The piece of steel (b) supports the mirror (a) along the back side.

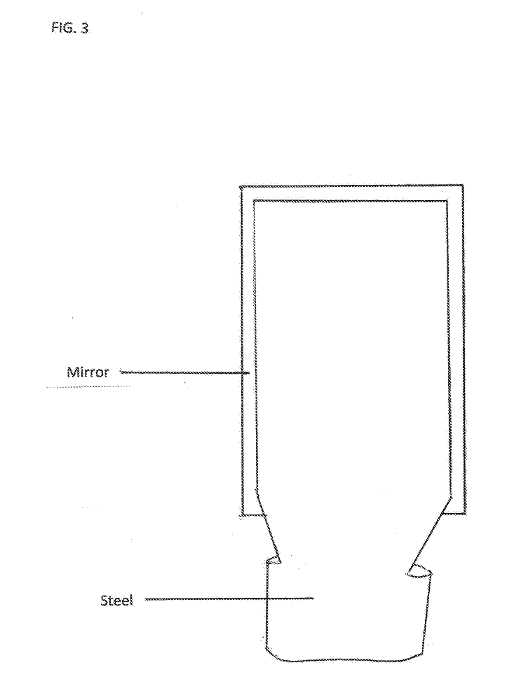

Description of view in Drawing of FIG. 4

FIG. 4) This is a view of light bulb reflector for an LED lightbulb. The material is 100% Coilzak. The clamp fastens around the light socket typically in a ceiling light luminaire assembly.

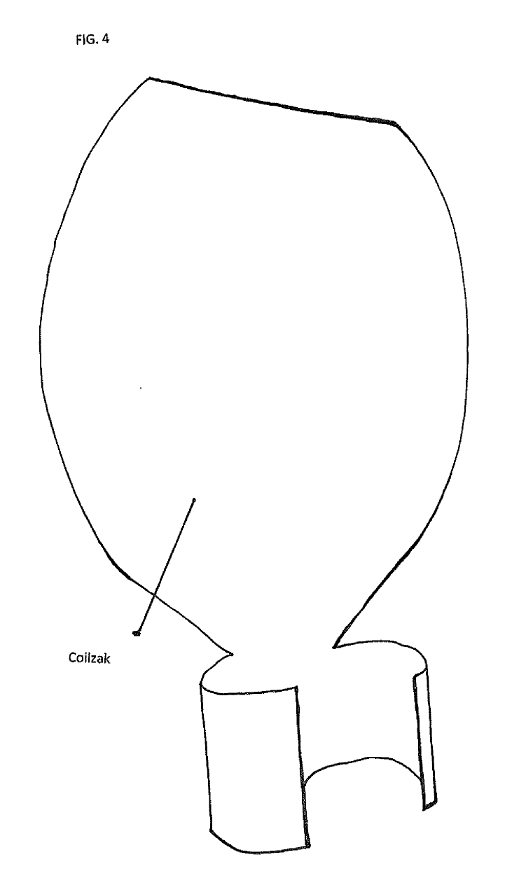

### REFERENCE

a—Coilzak

### DETAILED DESCRIPTION OF INVENTION

This reflector is made of a flat galvanized steel sheet and a mirror. The steel is cut into a rectangular shape the same width and height of a cfl light bulb. Then sections are cut out so it follows the shape of the bulb and leaves room for the bottom area to wrap around the light socket. The bottom is cut shorter so that it extends ¾ of the way down the light socket and wraps around the light socket. A rectangular glass mirror that is 6½ mm by 9½ mm is glued onto the steel with JB Weld glue. The reflector is designed to sit just above the light bulb creating more downward light.

In a typical telling light, the testing cfl light bulb has a lux reading of 920, measured a foot away from the bulb. After the Light Bulb Reflector is fastened to the light socket, the light bulb and reflector have readings of 1010, 1200, and 1300 lux from 3 different angles, measured a foot away from the bulb. Total light emitted by the lamp has been increased by up to 41%, which creates greater lighting efficiency.

1. An accessory reflector piece designed to sit on approximately ¼ of the side of a light bulb. The reflector piece sized in the proportion of 6.5 mm by 9.5 mm in relation to a type T3 Coil series bulb. The reflector piece having the circumference of 14.25 inches, in relation to a type T3 Led bulb. And sized proportionately as specified to each of the light bulb series sizes and bulb shapes: A, B, C, F, G, PS, RP, S, Compact Fluorescent Coils, Compact Fluorescent Plug In Lamps.
The reflector being flat or nearly flat or curved slightly toward the bulb so as to fit in a ceiling luminaire or wall luminaire, and standing lamps.
The reflector piece being in proximity of nearly touching the bulb or touching the bulb.
